(19) United States
(12) Patent Application Publication
(10) Pub. No.: US 2016/0128022 A1
(43) Pub. Date: May 5, 2016

(54) METHOD AND APPARATUS FOR RECEIVING CONTROL INFORMATION FOR REMOVING INTERFERENCE OF ADJACENT CELL IN WIRELESS ACCESS SYSTEM

(71) Applicant: LG ELECTRONICS INC., Seoul (KR)

(72) Inventors: Changhwan PARK, Anyang-si (KR); Changsoo LEE, Anyang-si (KR); Yusung LEE, Anyang-si (KR)

(73) Assignee: LG ELECTRONICS INC., Seoul (KR)

(21) Appl. No.: 14/894,949

(22) PCT Filed: May 31, 2013
(86) PCT No.: PCT/KR2013/004818

§ 371 Date: Nov. 30, 2015

(30) Foreign Application Priority Data
Jun. 10, 2013 (CA) 2818045

(51) Int. Cl. H04W 72/00; H04W 72/08; H04B 17/309; H04W 72/04

(52) U.S. Cl. CPC H04W 72/005; H04W 72/042; H04W 72/082; H04B 17/309

(57) ABSTRACT

A method for receiving control information for removing interference of an adjacent cell in a wireless access system, according to one embodiment of the present invention, comprises the steps of: receiving, from a serving cell, indication information expressing whether the number of resource blocks in the serving cell and in the adjacent cell match, and whether the number of antennas in the serving cell and in the adjacent cell are match; receiving a physical broadcast channel (PBCH) of the adjacent cell when the number of resource blocks and/or the number of antennas do not match; and determining the number of resource blocks and/or the number of antennas of the adjacent cell from the physical broadcast channel in the adjacent cell that has been received.

### FIELD OF THE INVENTION

The following description relates to a wireless communication system and, most particularly, to a method and apparatus for receiving control information for removing interference of an adjacent cell in a wireless access system.

### BACKGROUND ART

FIG. 1 illustrates a heterogeneous network wireless communications system including a macro base station (eNB1) and a micro base station (eNB2). In the description of the present invention, the term heterogeneous network refers to a network wherein a macro base station (110) and a micro base station (120) co-exist even when the same RAT (Radio Access Technology) is being used.

A macro base station (110) refers to a general base station of a wireless communication system having a broad coverage (service providing region (or area)) and a high transmission power. Herein, the macro base station (110) may also be referred to a macro cell. The micro base station (120) may also be referred to as a micro cell, a pico cell, a femto cell, a home eNB (HeNB), a relay, and so on. The micro base station (120) corresponds to a small-sized version (or compact version) of the macro base station (110). Accordingly, the micro base station (120) may independently perform most of the functions of the macro base station. Herein, the micro base station (120) may correspond to an overlay type base station, which may be installed in an area covered by the macro base station, or to a non-overlay type base station, which may be installed in a shadow area that cannot be covered by the macro base station. As compared to the macro base station (110), the micro base station (120) has a narrower coverage and a lower transmission power and may accommodate a smaller number of terminals (or user equipments).

A user equipment (UE) (or terminal) (130) may directly receive services from (or be serviced by) the macro base station (110) (hereinafter referred to as a macro-UE). And, alternatively, a user equipment (UE) (130) may directly receive services from (or be serviced by) the micro base station (120) (hereinafter referred to as a micro-UE). In some cases, a user equipment (UE) (130) existing within the coverage area of the micro base station (120) may receive services from the macro base station (110). FIG. 1 illustrates an exemplary state, wherein the user equipment (UE) (130) is connected to the micro base station (120).

Depending upon whether or not the user equipment has limited access, the micro base station may be categorized into two different types. The first type corresponds to a CSG (Closed Subscriber Group) micro base station, and the second type corresponds to an OA (Open Access) or OSC (Open Subscriber Group) micro base station. The CSG micro base station may service (or transmit services to) only specific user equipments that are authorized, and the OSG micro base station may service (or transmit services to) all types of user equipments without any particular access limitations.

### DETAILED DESCRIPTION OF THE INVENTION

### Technical Objects

As shown in the example of FIG. 1, in case the user equipment (130), which is serviced by the micro base station (120) in the heterogeneous network, receives a desired signal from the micro base station (120), there may occur a case when interference is caused by a strong signal transmitted from the macro base station. Alternatively, when a user equipment (130), which is being serviced by the macro base station, is adjacent to the micro base station, interference may occur on the signal transmitted from the macro base station, which is received by the user equipment, due to a strong signal transmitted from the micro base station. Such interference may be referred to as an inter-cell interference, and the example presented above corresponds to an inter-cell interference, which occurs in a downlink from the base station to the user equipment. Similarly, inter-cell interference may also occur in an uplink from the user equipment to the base station.

In a cellular system, a method of alleviating or removing (or eliminating) inter-cell interference between adjacent (or neighboring) cells may be broadly divided into two different types. A first method corresponds to a method of alleviating interference by using a channel statistical characteristic of a signal, which is received from a neighboring (or adjacent) cell. For example, this may correspond to a method of removing an interference signal, by using a correlation between interference signals, which are received by multiple reception antennas, and combining the remaining signals. Additionally, a MMSE (Minimum Mean Square Error)-IRC (Interference Rejection combining) method also corresponds to such interference removing method. A second method corresponds to a method of detecting and removing a signal that is received from a neighboring cell. A PBCH (Physical Broadcast Channel) Cancellation method, a CRS (Common Reference Signal) removing method may correspond to this.

In case of applying the above-described interference alleviating removing methods, channel information corresponding to a statistical characteristic and an instantaneous characteristic respective to a channel of a neighboring cell is required. At this point, the channel information of a neighboring cell may be acquired by using CRS. The CRS is defined as parameters of a cell identifier (Cell Identification), a slot number, an OFDM (Orthogonal Frequency Division Multiple) symbol index (or number), a CP (Cyclic Prefix) length, a number of resource blocks (RBs), a number of transmission antennas. Generally, in a cellular system, for handover, and so on, the user equipment tracks and manages reception signal power or quality of a neighboring cell in addition to the serving cell. During this procedure, among the parameters for defining the CRS, the user equipment may acquire information excluding a number of downlink resource blocks and a number of transmission antennas.

An object of the present invention is to provide a method of effectively acquiring information on a number of downlink resource blocks and a number of antennas of an adjacent cell in order to remove or alleviate interference of an adjacent cell.

The effects of the present invention will not be limited only to the technical objects described above. Accordingly, technical objects that have not been mentioned above or additional technical objects of the present application may become apparent to those having ordinary skill in the art from the description presented below.

### TECHNICAL SOLUTIONS

To achieve these objects and other advantages and in accordance with the purpose of the invention, a method for receiving control information for removing interference of an adjacent cell in a wireless access system, the method for receiving control information comprising: receiving, from a serving cell, indication information expressing whether numbers of resource blocks in a serving cell and in an adjacent cell match, and whether numbers of antennas in the serving cell and in the adjacent cell match; receiving a physical broadcast channel (PBCH) of the adjacent cell when the numbers of resource blocks and/or the numbers of antennas do not match; and determining the number of resource blocks and/or the number of antennas of the adjacent cell from the physical broadcast channel in the adjacent cell that has been received.

In another aspect of the present invention, the indication information is given a matching value when both the numbers of resource blocks and the numbers of antennas match, and wherein the indication information is given a non-matching value when at least one of the numbers does not match.

In another aspect of the present invention, if the indication information is given a matching value, the number of resource blocks and the number of antennas of the adjacent cell are determined from the received physical broadcast channel of the adjacent cell.

In another aspect of the present invention, the indication information comprises first information indicating whether or not the numbers of resource blocks match, and second information indicating whether or not the numbers of antennas match.

In another aspect of the present invention, information corresponding to the non-match is determined from the received physical broadcast channel of the adjacent cell when at least one of the first information and the second information indicates a non-match.

In another aspect of the present invention, the indication information is received through a MIB (Master Information Block) message.

In another aspect of the present invention, the indication information is received through a RA-RNTI (Random Access-Radio Network Temporary Identifier) message.

In another aspect of the present invention, the indication information is received through a PDSCH (Physical Downlink Control Channel).

In another aspect of the present invention, the indication information is received through a MAC (Medium Access Control) control element.

In another aspect of the present invention, the indication information is received through a RRC (Radio Resource Control) message.

In another aspect of the present invention, the indication information is received through a SIB (System Information Block) message.

In another aspect of the present invention, further comprising: receiving CRS of the adjacent cell by using the number of resource blocks of the adjacent cell and the number of antennas of the adjacent cell.

In another aspect of the present invention, further comprising: estimating a channel of the adjacent cell by using the CRS of the adjacent cell.

In another aspect of the present invention, further comprising: controlling interference caused by the adjacent cell in a receiving signal transmitted from the serving cell by using the estimated channel of the adjacent cell.

In another aspect of the present invention, a user equipment receiving control information for removing interference of an adjacent cell in a wireless access system, the user equipment comprises: a RF (Radio Frequency) unit; and a processor, wherein the processor is configured to: receive, from a serving cell, indication information expressing whether numbers of resource blocks in a serving cell and in an adjacent cell match, and whether numbers of antennas in the serving cell and in the adjacent cell match, receive a physical broadcast channel (PBCH) of the adjacent cell when the numbers of resource blocks and/or the numbers of antennas do not match, and determine the number of resource blocks and/or the number of antennas of the adjacent cell from the physical broadcast channel in the adjacent cell that has been received.

It is to be understood that both the foregoing general description and the following detailed description of the present invention are exemplary and explanatory and are intended to provide further explanation of the invention as claimed.

### Advantageous Effects

According to the present invention, when receiving control information in order to estimate a channel of an adjacent cell in a wireless access system, a solution for detecting PBCH of an adjacent cell only when required may be provided by using indication information, which indicates whether or not a number of resource blocks and a number of antennas of the adjacent cell matches a number of resource blocks and a number of antennas of a serving cell.

The effects of the present invention will not be limited only to the effects described above. Accordingly, effects that have not been mentioned above or additional effects of the present application may become apparent to those having ordinary skill in the art from the description presented below.

### BRIEF DESCRIPTION OF THE DRAWINGS

The accompanying drawings, which are included in this specification in order to provide a further understanding of the present invention, provide exemplary embodiments of the present invention and describe the principles of the present invention along with the detailed description of this specification.

FIG. 1 illustrates a heterogeneous network wireless communication system.

FIG. 2 illustrates physical channels of a LTE system and an exemplary signal transmission using the same.

FIG. 3 illustrates a structure of a downlink radio frame (or wireless frame).

FIG. 4 illustrates an exemplary resource grid in a downlink slot.

FIG. 5 illustrates a structure of a downlink subframe.

FIG. 6 illustrates a structure of an uplink subframe.

FIG. 7 illustrates a block view showing a structure of a wireless communication system having multiple antennae (or antennas).

FIG. 8 illustrates CRS and DRS patterns that are defined in a legacy 3GPP LTE system.

FIG. 9 illustrates a flow chart of a method for receiving control information for removing interference of a neighboring cell according to an exemplary embodiment of the present invention.

FIG. 10 illustrates exemplary base station and user equipment that can be applied to an exemplary embodiment of the present invention.

### BEST MODE FOR CARRYING OUT THE PRESENT INVENTION

The following embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be substituted with corresponding structural elements or features of another embodiment.

In this specification, embodiments of the present invention are described centering on the data transmission/reception relations between a base station and a terminal. In this case, the base station may be meaningful as a terminal node of a network which directly performs communication with the terminal. In this disclosure, a specific operation explained as performed by a base station may be performed by an upper node of the base station in some cases.

In particular, in a network constructed with a plurality of network nodes including a base station, it is apparent that various operations performed for communication with a terminal can be performed by a base station or other networks except the base station. ‘Base station (BS)’ may be substituted with such a terminology as a fixed station, a Node B, an eNode B (eNB), an access point (AP) and the like. A relay may be substituted with such a terminology as a relay node (RN), a relay station (RS) and the like. And, ‘terminal’ may be substituted with such a terminology as a user equipment (UE), a mobile station (MS), a mobile subscriber station (MSS), a subscriber station (SS), a station (STA) and the like.

Specific terminologies used for the following description may be provided to help the understanding of the present invention. And, the use of the specific terminology may be modified into other forms within the scope of the technical idea of the present invention.

Occasionally, to avoid obscuring the concept of the present invention, structures and/or devices known to the public may be skipped or represented as block diagrams centering on the core functions of the structures and/or devices. Wherever possible, the same reference numbers will be used throughout the drawings to refer to the same or like parts in this specification.

The embodiments of the present invention may be supported by the disclosed standard documents of at least one of wireless access systems including IEEE 802 system, 3GPP system, 3GPP LTE system, LTE-A (LTE-Advanced) system and 3GPP2 system. In particular, the steps or parts, which are not explained to clearly reveal the technical idea of the present invention, in the embodiments of the present invention may be supported by the above documents. Moreover, all terminologies disclosed in this document may be supported by the above standard documents.

The following description of embodiments of the present invention may apply to various wireless access systems including CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc. UTRA is a part of UMTS (Universal Mobile Telecommunications System). 3GPP (3rd Generation Partnership Project) LTE (long term evolution) is a part of E-UMTS (Evolved UMTS) that uses E-UTRA. The 3GPP LTE adopts OFDMA in downlink and SC-FDMA in uplink. And, LTE-A (LTE-Advanced) is an evolved version of 3GPP LTE. WiMAX may be supported by IEEE 802.16e standard (WirelessMAN-OFDMA Reference System) advanced IEEE 802.16m (WirelessMAN-OFDMA Advanced System). For clarity, the present invention is described centering on IEEE 802.11 system. However, the technical idea of the present invention will not be limited thereto.

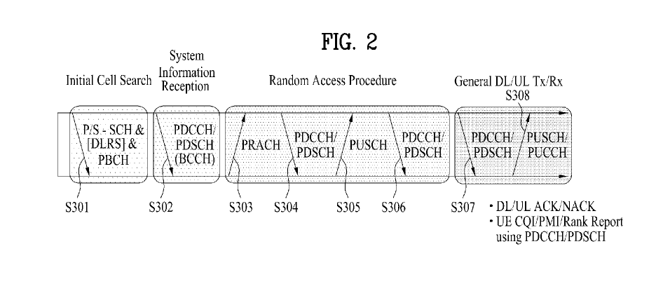

FIG. 2 illustrates physical channels in LTE system and signal transmission using the same.

If power of a user equipment is turned on or the user equipment enters a new cell, the user equipment performs an initial cell search for matching synchronization with a base station and the like [S301]. To this end, the user equipment receives a primary synchronization channel (P-SCH) and a secondary synchronization channel (S-SCH) from the base station, matches synchronization with the base station and is then able to obtain information such as a cell identity (ID) and the like. Subsequently, the user equipment receives PBCH (physical broadcast channel) from the base station and is then able to obtain intra-cell broadcast information.

As a representative example of the intra-cell broadcast information, system information may be considered. The system information is repeatedly broadcasted through PBCH and is necessary for a user equipment to access a cell and to operate in the cell. The system information includes MIB (master information block) and SIBs (system information blocks). Table 1 shows one example of MIB.

TABLE 1
--ASN1START

| MasterInformationBlock ::= | | SEQUENCE { |
|---|---|---|
| | dl-Bandwidth | ENUMERATED {n6, n15, n25, n50, n75, |
| | | n100}, |
| | phich-Config | PHICH-Config, |
| | systemFrameNumber | BIT STRING (SIZE (8)), |
| | spare | BIT STRING (SIZE (10)) |

}
--ASN1STOP

As shown in Table 1, MIB includes a downlink system bandwidth (DL BW: dl-Bandwidth), PHICH (Physical Hybrid-ARQ Indicator Channel) configuration, and SFN (System Frame Number). Additionally, 10 bits (spare) are remained in a reserved field instead of being used. By receiving the MIB, the user equipment (UE) may be capable of explicitly knowing the information on the DL BW, SFN, and PHICH configuration. The PHICH configuration includes a number of OFDM symbols that are occupied by the PHICH region (or area), and information on an amount of resource (or resource size) being reserved for the PHICH within the control region.

Once the user equipment has completed the initial cell search, the corresponding user equipment may acquire more detailed system information by receiving a Physical Downlink Control Channel (PDCCH) and a Physical Downlink Control Channel (PDSCH) based upon the respective information carried in the PDCCH (S302).

Meanwhile, if the user equipment initially accesses the base station, or if there are no radio resources for signal transmission, the user equipment may perform a Random Access Procedure (RACH) with respect to the base station (S303 to S306). In order to do so, the user equipment may transmit a specific sequence to a preamble through a Physical Random Access Channel (PRACH) (S303 and S305), and may receive a response message respective to the preamble through the PDCCH and the PDSCH corresponding to the PDCCH (S304 and S306). In case of a contention based RACH, a Contention Resolution Procedure may be additionally performed.

After performing the above-described process steps, the user equipment may perform PDCCH/PDSCH reception (S307) and Physical Uplink Shared Channel (PUSCH)/Physical Uplink Control Channel (PUCCH) transmission (S308), as general uplink/downlink signal transmission procedures. The control information, which is transmitted by the user equipment to the base station or received by the user equipment from the base station via uplink, includes downlink/uplink ACK/NACK signals, a CQI (Channel Quality Indicator), a PMI (Precoding Matrix Index), an RI (Rank Indicator), and so on. In case of the 3GPP LTE system, the user equipment may transmit control information, such as the above-described CQI/PMI/RI through the PUSCH and/or the PUCCH.

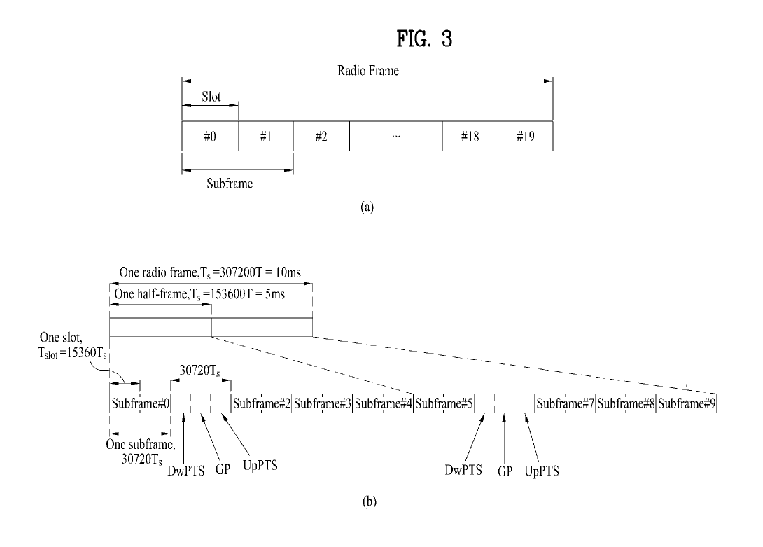

A structure of a downlink radio frame (or wireless frame) will be described in detail with reference to FIG. 3.

In a cellular OFDM radio packet communication system, uplink/downlink data packet transmission is performed in subframe units, and once subframe is defined as a predetermined time period (or time section) including multiple OFDM symbols. The 3GPP LTE standard supports a Type 1 radio frame structure, which is applicable to FDD (Frequency Division Duplex), and a Type 2 radio frame structure, which is applicable to TDD (Time Division Duplex).

FIG. 3(a) illustrates an exemplary structure of a type 1 radio frame. A downlink radio (or wireless) frame is configured of 10 subframes, and one subframe is configured of 2 slots in a time domain. The time consumed (or taken) for one subframe to be transmitted is referred to as a TTI (transmission time interval). For example, the length of one subframe may be equal to 1 ms, and the length of one slot may be equal to 0.5 ms. One slot includes a plurality of OFDM symbols in the time domain and includes a plurality of Resource Blocks (RBs) in the frequency domain. Since the 3GPP LTE system uses the OFDMA in a downlink, an OFDM symbol represents one symbol section. The OFDM symbol may also be referred to as an SC-FDMA symbol or a symbol section. A Resource Block (RB) corresponds to a resource allocation unit, and the Resource Block (RB) may include a plurality of consecutive subcarriers in one slot.

The number of OFDM symbols included in one slot may vary depending upon the configuration of a CP (Cyclic Prefix). The CP may be divided into an extended CP and a normal CP. For example, in case the OFDM symbol is configured of a normal CP, the number of OFDM symbols included in one slot may be equal to 7. And, in case the OFDM symbol is configured of an extended CP, since the length of an OFDM symbol is increased, the number of OFDM symbols included in one slot becomes smaller than when the OFDM symbol is configured of a normal CP. In case of the extended CP, for example, the number of OFDM symbols included in one slot may be equal to 6. In case the user equipment is moving at a high speed, or in case the channel status is unstable, the extended CP may be used in order to further reduce the interference between the symbols.

In case of using the normal CP, since one slot includes 7 OFDM symbols, one subframe includes 14 OFDM symbols. At this point, the first 2 or 3 OFDM symbols of each subframe are allocated to a PDCCH (physical downlink control channel), and the remaining OFDM symbols may be allocated to a PDSCH (physical downlink shared channel).

FIG. 3(b) illustrates an exemplary structure of a type 2 radio frame. The type 2 radio frame consists of 2 half frames, and each half frame is configured of 5 general subframes and a DwPTS (Downlink Pilot Time Slot), a Guard Period (GP), and a UpPTS (Uplink Pilot Time Slot), wherein 1 subframe is configured of 2 slots. The DwPTS is used for performing initial cell search, synchronization or channel estimation in the user equipment. And, the UpPTS is used for matching a channel estimation performed in the based station with an uplink transmission synchronization performed in the user equipment. The guard period refers to a period for eliminating (or removing) interference that occurs in an uplink, due to a multiple path delay of a downlink signal between an uplink and a downlink. Meanwhile, regardless of the type of radio frame, one subframe is configured of 2 slots.

The radio frame is merely exemplary, and, therefore, the number of subframes included in the radio frame or the number of slots included in a subframe, and the number of symbols included in one slot may be diversely varied.

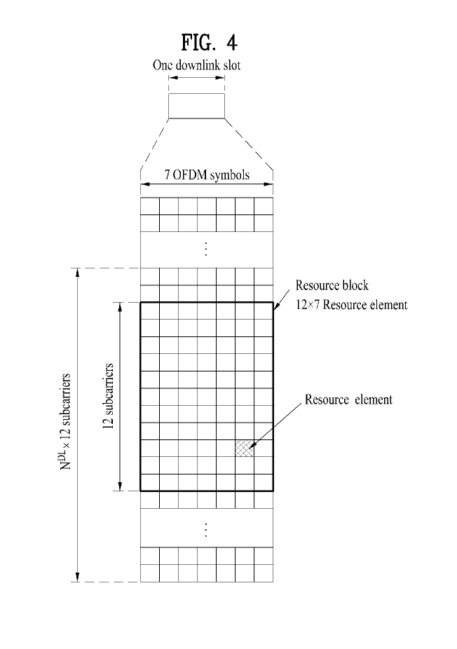

FIG. 4 illustrates an exemplary resource grid in a downlink slot. Although it is shown that one downlink slot includes 7 OFDM symbols in a time domain, and that one resource block (RB) includes 12 sub-carriers in a frequency domain, this is merely exemplary. And, therefore, the present invention will not be limited only to the example presented herein. For example, in case of a general Cyclic Prefix (CP), one slot includes 7 OFDM symbols. Alternatively, in case of an extended Cyclic Prefix (extended-CP), one slot may include 6 OFDM symbols. Referring to FIG. 4, each element configuring the resource grid is referred to as a resource element. One resource block includes 12×7 resource elements. An NDL number of resource blocks included in a downlink slot may vary in accordance with a downlink transmission bandwidth. The structure of an uplink slot may be identical to the above-described structure of the downlink slot.

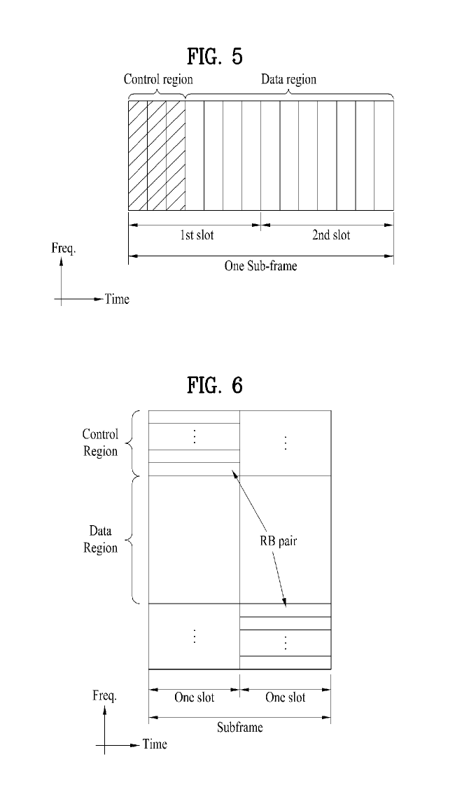

FIG. 5 illustrates a structure of a downlink subframe. A maximum of 3 OFDM symbols located at the front portion of a first slot within one sub-frame corresponds to a control region wherein a control channel is allocated (or assigned). The remaining OFDM symbols correspond to a data region wherein a Physical Downlink Shared Channel (PDSCH) is assigned. Downlink control channels that are being used in the 3GPP LTE system may include a Physical Control Format Indicator Channel (PCFICH), a Physical Downlink Control Channel (PDCCH), a Physical Hybrid automatic repeat request Indicator Channel (PHICH), and so on. The PCFICH includes information on the number of OFDM symbols being transmitted from the first OFDM symbol of a sub-frame and being used in the control channel transmission within the sub-frame. As a response to an uplink transmission, the PHICH includes HARQ ACK/NACK signals. The control information being transmitted through the PDCCH is referred to as Downlink Control Information (DCI). Herein, the DCI may include uplink or downlink scheduling information or may include an uplink transmission power control command on a random terminal (or user equipment) group. The PDCCH may include information on resource allocation and transmission format of a downlink shared channel (DL-SCH), information on resource allocation of an uplink shared channel (UL-SCH), paging information of a paging channel (PCH), system information of the DL-SCH, resource allocation of an upper layer (or higher level) control message, such as a Random Access Response, that is being transmitted over the PDSCH, a set of transmission power control commands on individual user equipments within the random user equipment group, transmission power control information, information on the activation of a Voice over IP (VoIP), and so on. A plurality of PDCCHs may be transmitted within the control region. And, the user equipment may monitor the plurality of PDCCHs. Herein, the PDCCH may be transmitted in the form of a combination of at least one or more consecutive Control Channel Elements (CCEs). A CCE corresponds to a logical allocation unit used for providing a PDCCH at a coding rate based on a wireless channel state. Herein, the CCR corresponds to a plurality of resource element groups. The number of formats and available data bits of a PDCCH may be decided based upon a correlation between the number of CCEs and the coding rate provided by the CCEs. The base station decides a PDCCH format in accordance with the DCI being transmitted to the user equipment and adds a (Cyclic Redundancy Check; CRC) to the control information. Depending upon the owner or purpose of the PDCCH, the CRC may be masked by a Radio Network Temporary Identifier (RNTI). If the PDCCH belongs to a particular (or specific) user equipment, a cell-RNTI (C-RNTI) identifier of the user equipment may be masked to the CRC. Alternatively, if the PDCCH belongs to a paging message, a Paging Indicator Identifier (P-RNTI) may be masked to the CRC. If the PDCCH belongs to a system information (more specifically, a system information block (SIB)), a system information identifier, and a system information RNTI (SI-RNTI) may be masked to the CRC. In order to indicate the random access response, which corresponds to a response to the transmission of a random access preamble, of the user equipment, a random access RNTI (RA-RNTI) may be masked to the CRC.

FIG. 6 illustrates a structure of an uplink subframe. Referring to FIG. 6, a UL subframe may be divided into a data region and a control region in the frequency domain. A PUCCH (Physical Uplink Control Channel), which includes uplink control information, is allocated to the control region. And, a PUSCH (Physical Uplink Shared Channel), which carries user data, is allocated to the data region. In order to maintain the characteristics of a single carrier, one user equipment does not transmit a PUCCH and a PUSCH at the same time. A PUCCH respective to a user equipment is allocated to a Resource Block pair (RB pair) in a subframe. And, the RBs belonging to the RB pair occupy different subcarriers in two slots. This may also be described (or expressed) as the RB pair, which is allocated to the PUCCH, being frequency-hopped at a slot boundary.

Modeling of a Multiple Antennae (MIMO) System

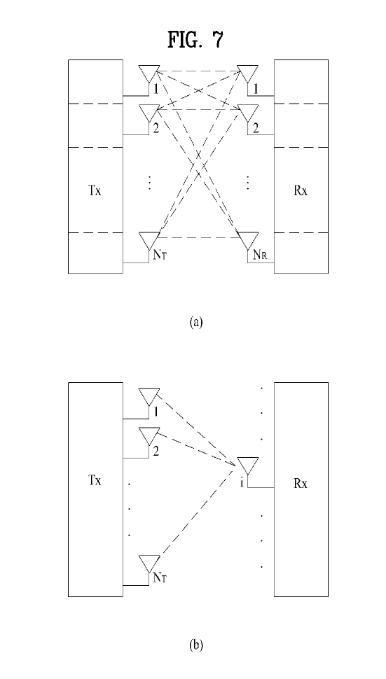

FIG. 7 illustrates a block view showing a structure of a wireless communication system having multiple antennae (or antennas).

As shown in FIG. 7(a), if the number of transmitting antennas is increased to NT, and if the number of receiving antennas is increased to NR, unlike in the case wherein multiple antennas are used only in the transmitter or the receiver, a logical channel transmission capacity increases in proportion with the number of antennas. Therefore, the transmission rate may be enhanced, and the frequency efficiency may be drastically enhanced. In accordance with the increase in the channel transmission capacity, the transmission rate may be increased as much as a value of a maximum transmission rate (Ro) multiplied by a rate increase ratio (Ri) when logically using a single antenna.

Rᵢ=min(N_{T},N_{R}) [Equation 1]

For example, in a MIMO communication system using 4 transmission antennas and 4 reception antennas, a theoretical transmission rate 4 times that of a single antenna system may be acquired. Evidence of such theoretical capacity increase of the multiple antennae system was found and proven in the mid 90's. And, since then, diverse technologies for actually enhancing the data transmission rate have been under research and development. And, among such technologies, some of the technologies are already being applied in diverse wireless communication standards, such as the 3^{rd} generation mobile communication and the next generation wireless LAN.

Up to the current time, the research and development associated to multiple antennas have been actively and diversely carried out in many aspects, such as research in the aspect of information theory associated to multiple antennae communication capacity calculation in diverse channel environments and multiple access environments, research in drawing out wireless channel measurements and models of a multiple antennae system, research in time/space signal processing technologies for enhancing transmission reliability and for enhancing the transmission rate, and so on.

A communications method in a multiple antennae system using mathematical modeling will now be described in detail. Herein, it is assumed that NT number of transmitting antennas and NR number of receiving antennas in the system.

Referring to a transmitted signal, when there is NT number of transmitting antennas, the maximum number of transmittable information is equal to NT. The transmission information may be expressed as shown below.

s=[s₁,s₂, . . . ,s_{N}_{_{T}}]^{T} [Equation 2]

Each of the transmission information s₁, s₂, . . . , s_{N}_{ₜ} may have a different transmission power. When each of the transmission power is referred to as P₁, P₂, . . . , P_{N}_{ₜ}, the transmission information wherein the respective transmission power is adjusted may be expressed as shown below.

s=[ŝ₁,ŝ₂, . . . ,ŝ_{N}_{_{T}}]^{T}=[P₁s₁,P₂s₂, . . . ,P_{N}_{_{T}}s_{N}_{_{T}}]^{T} [Equation 3]

Moreover, by using a diagonal matrix P of the transmission power, ŝ may be expressed as shown below.

$$\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{s}_{1} \\ {s}_{2} \\ ⋮ \\ {s}_{{N}_{T}}\end{matrix} ] = Ps \qquad [ Equation 4 ]$$

Herein, consideration is made on a case wherein NT number of transmitted signals x₁, x₂, . . . , x_{N}_{ₜ}, which are configured by having a weight matrix W applied to an information vector ŝ, wherein the transmission power is adjusted, so as to be actually transmitted. The weight matrix W performs the role of adequately distributing transmission information to each antenna in accordance with the transmission channel status. By using a vector x, x₁, x₂, . . . , x_{N}_{ₜ} may be expressed as shown below.

$$x = [ \begin{matrix}{x}_{1} \\ {x}_{2} \\ ⋮ \\ {x}_{i} \\ ⋮ \\ {x}_{{N}_{T}}\end{matrix} ] = [ \begin{matrix}{w}_{11} & {w}_{12} & … & {w}_{1 {N}_{T}} \\ {w}_{21} & {w}_{22} & … & {w}_{2 {N}_{T}} \\ ⋮ & & ⋱ & \\ {w}_{i 1} & {w}_{i 2} & … & {w}_{{iN}_{T}} \\ ⋮ & & ⋱ & \\ {w}_{{N}_{T} 1} & {w}_{{N}_{T} 2} & … & {w}_{{N}_{T} {N}_{T}}\end{matrix} ] [ \begin{matrix}{\hat{s}}_{1} \\ {\hat{s}}_{2} \\ ⋮ \\ {\hat{s}}_{j} \\ ⋮ \\ {\hat{s}}_{{N}_{T}}\end{matrix} ] = W \hat{s} = WPs \qquad [ Equation 5 ]$$

Herein, wᵢⱼ represents a weight between an i^{th} transmitting antenna and a j^{th} information. W may also be referred to as a precoding matrix.

When there are NR number of receiving antennas, the received signals y₁, y₂, . . . , y_{N}_{_{R}} of may be expressed as a vector as shown below.

y=[y₁,y₂, . . . ,y_{N}_{_{R}}]^{T} [Equation 6]

In case of modeling a channel in a multiple antennae wireless communication system, a channel may be differentiated (or identified) in accordance with a transmitting antenna index. Herein, a channel passing through receiving antenna i from transmitting antenna j will be expressed as hᵢⱼ. In hᵢⱼ, it should be noted that, in the index order, the receiving antenna index comes first, and the transmitting antenna index comes next.

Meanwhile, FIG. 7(b) illustrates a channel from NT number of transmitting antennas to receiving antenna i. The channel may be grouped so as to be expressed in the form of a vector and a matrix. In FIG. 7(b), a channel starting from a total of NT number of transmitting antennas and being received to receiving antenna i may be expressed as shown below.

hᵢ^{T}=[hᵢ₁,hᵢ₂, . . . h_{iN}_{_{T}}] [Equation 7]

Therefore, all channels starting from NT number of transmitting antennas and being received to NR number of receiving antennas may be expressed as shown below.

$$H = [ \begin{matrix}{h}_{1}^{T} \\ {h}_{2}^{T} \\ ⋮ \\ {h}_{i}^{T} \\ ⋮ \\ {h}_{{N}_{R}}^{T}\end{matrix} ] = [ \begin{matrix}{h}_{11} & {h}_{12} & … & {h}_{1 {N}_{T}} \\ {h}_{21} & {h}_{22} & … & {h}_{2 {N}_{T}} \\ ⋮ & & ⋱ & \\ {h}_{i 1} & {h}_{i 2} & … & {h}_{{iN}_{T}} \\ ⋮ & & ⋱ & \\ {h}_{{N}_{R} 1} & {h}_{{N}_{R} 2} & … & {h}_{{N}_{R} {N}_{T}}\end{matrix} ] \qquad [ Equation 8 ]$$

An actual channel passes through a channel matrix H, and an AWGN (Additive White Gaussian Noise) is added to the processed channel. The AWGN (Additive White Gaussian Noise) n₁, n₂, . . . , n_{N}_{_{R}} being added to each of the NR number of receiving antennas may be expressed as shown below.

n=[n₁,n₂, . . . ,n_{N}_{_{R}}]^{T} [Equation 9]

A received signal may be expressed as shown below through the above-described equation modeling.

$$y = [ \begin{matrix}{y}_{1} \\ {y}_{2} \\ ⋮ \\ {y}_{i} \\ ⋮ \\ {y}_{{N}_{R}}\end{matrix} ] = [ \begin{matrix}{h}_{11} & {h}_{12} & … & {h}_{1 {N}_{T}} \\ {h}_{21} & {h}_{22} & … & {h}_{2 {N}_{T}} \\ ⋮ & & ⋱ & \\ {h}_{i 1} & {h}_{i 2} & … & {h}_{{iN}_{T}} \\ ⋮ & & ⋱ & \\ {h}_{{N}_{R} 1} & {h}_{{N}_{R} 2} & … & {h}_{{N}_{R} {N}_{T}}\end{matrix} ] [ \begin{matrix}{x}_{1} \\ {x}_{2} \\ ⋮ \\ {x}_{j} \\ ⋮ \\ {x}_{{N}_{T}}\end{matrix} ] + [ \begin{matrix}{n}_{1} \\ {n}_{2} \\ ⋮ \\ {n}_{i} \\ ⋮ \\ {n}_{{N}_{R}}\end{matrix} ] = Hx + n \qquad [ Equation 10 ]$$

Meanwhile, the number of rows and columns in a channel matrix H indicating the channel state may be decided by the number of transmitting and receiving antennas. The number of rows in the channel matrix H is equal to the number of receiving antennas NR, and the number of columns in the channel matrix H is equal to the number of transmitting antennas NT. More specifically, the channel matrix H corresponds to a matrix of NR×NT.

A rank of a matrix is defined as a minimum number among the number of rows or columns that are independent from one another. Therefore, the rank of a matrix cannot be greater than the number of rows or the number of columns. The rank (rank(H)) of the channel matrix is limited as shown below.

rank(H)≦min(N_{T},N_{R}) [Equation 11]

Another definition of the rank may be defined as a number of Eigen values other than 0, when the matrix is processed with Eigen value decomposition. Similarly, yet another definition of the rank may be defined as a number of singular values other than 0, when the matrix is processed with a singular value decomposition. Therefore, in the channel matrix, the physical definition of a rank may correspond to a maximum number of information that can be transmitted from a given channel.

Reference Signal (RS)

In a radio communication system, since packets are transmitted through a radio channel, a signal may be distorted during transmission. In order to enable a reception side to correctly receive the distorted signal, distortion of the received signal should be corrected using channel information. In order to detect the channel information, a method of transmitting a signal, of which both the transmission side and the reception side are aware, and detecting channel information using a distortion degree when the signal is received through a channel is mainly used. The above signal is referred to as a pilot signal or a reference signal (RS).

When transmitting and receiving data using multiple antennas, the channel states between the transmission antennas and the reception antennas shall be detected in order to correctly receive the signal. Accordingly, each transmission antenna has an individual RS.

A downlink RS includes a Common RS (CRS) shared among all UEs in a cell and a Dedicated RS (DRS) for only a specific-UE. It is possible to provide information for channel estimation and demodulation using such RSs.

The receiving end (UE) estimates the channel state from the CRS and feeds back an indicator associated with channel quality, such as a Channel Quality Indicator (CQI), a Precoding Matrix Index (PMI) and/or a Rank Indicator (RI), to the transmission side (eNodeB). The CRS may be also called a cell-specific RS. Alternatively, an RS associated with the feedback of Channel State Information (CSI) such as CQI/PMI/RI may be separately defined as a CSI-RS.

Meanwhile, the DRS may be transmitted through REs if data demodulation on a PDSCH is necessary. The UE may receive the presence/absence of the DRS from a higher layer and receive information indicating that the DRS is valid only when the PDSCH is mapped. The DRS may be also called a UE-specific RS or a Demodulation RS (DMRS).

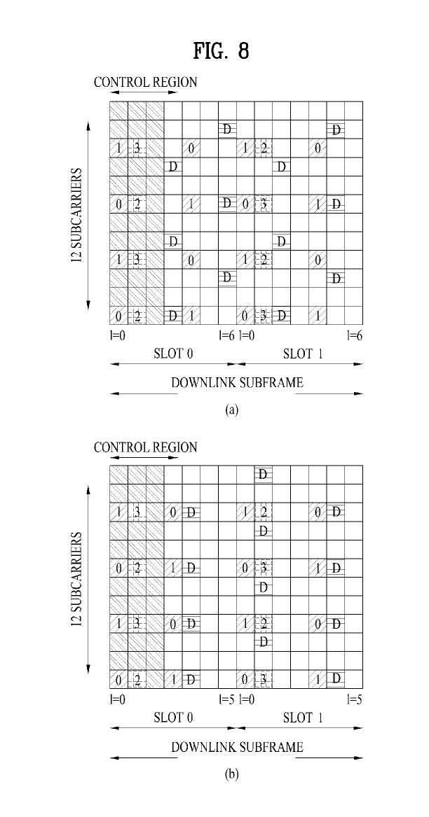

FIG. 8 illustrates a pattern of CRSs and DRSs mapped on a downlink RB pair defined in the existing 3GPP LTE system (e.g., Release-8). The downlink RB pair as a mapping unit of the RSs may be expressed in units of one subframe on a time domain×12 subcarriers on a frequency domain. That is, on the time axis, one RB pair has a length of 14 OFDM symbols in case of the normal CP (FIG. 8(a)) and has a length of 12 OFDM symbols in case of the extended CP (FIG. 8(b)).

FIG. 8 shows the locations of the RSs on the RB in the system in which the eNodeB supports four transmission antennas. In FIG. 8, Resource Elements (REs) marked as ‘0’, ‘1’, ‘2’ and ‘3’ indicate the locations of the CRSs of the antenna port indexes 0, 1, 2 and 3, respectively. In FIG. 8, the RE marked as ‘D’ indicates the location of the DRS.

Hereinafter, the CRS will be described in detail.

The CRS is used in order to estimate a channel of a physical antenna group, and, as a reference signal that can be commonly received by all of the user equipments (UEs) within a cell, the CRS is distributed through the entire band. The CRS may be used for the purpose of acquiring channel state information (CSI) acquisition and data demodulation.

The CRS is defined in diverse formats in accordance with the antenna configuration of the transmitting end (base station). A 3GPP LTE (e.g., Release-8) system supports diverse Antenna configurations, and a downlink signal transmitting end (base station) has 3 different types of antenna configurations, such as a single antenna, 2 transmission antennas, 4 transmission antennas, and so on. In case the base station transmits a single antenna, a reference signal for a single antenna port is positioned. In case the base station transmits 2 transmission antennas, reference signals for 2 antenna ports are positioned by using a Time Division Multiplexing method and/or Frequency Division Multiplexing method. More specifically, the reference signals for 2 antenna ports may be differentiated from one another by being positioned in different time resources and/or different frequency resources. Additionally, in case the base station transmits 4 transmission antennas, reference signals for 4 antenna ports are positioned by using the TDM method and/or the FDM method. The channel information that is estimated by a downlink receiving end (user equipment) through the CRS may be used for demodulating the transmitted data by using transmission methods, such as Single Antenna Transmission, Transmit diversity, Closed-loop Spatial multiplexing, Open-loop Spatial multiplexing, Multi-User MIMO (MU-MIMO), and so on.

In case of supporting multiple antennas, when a reference signal is transmitted from a specific antenna port, the reference signal is transmitted to a resource element (RE) position, which is designated in accordance with a reference signal pattern, and no other signal is transmitted to a resource element (RE) position, which is designated for another antenna port.

The rule according to which the CRS is being mapped within the resource block follows Equation 12 shown below.

$$k = 6 m + ( v + {v}_{shift} ) mod 6 \\ l = \{ \begin{matrix}0 , {N}_{symb}^{DL} - 3 & if p ∈ \{ 0 , 1 \} \\ 1 & if p ∈ \{ 2 , 3 \}\end{matrix} \\ m = 0 , 1 , … , 2 \cdot {N}_{RB}^{DL} - 1 \\ {m}^{′} = m + {N}_{RB}^{max , DL} - {N}_{RB}^{DL} \\ v = \{ \begin{matrix}0 & if p = 0 and l = 0 \\ 3 & if p = 0 and l \neq 0 \\ 3 & if p = 1 and l = 0 \\ 0 & if p = 1 and l \neq 0 \\ 3 ( {n}_{s} mod 2 ) & if p = 2 \\ 3 + 3 ( {n}_{s} mod 2 ) & if p = 3\end{matrix} \\ {v}_{shift} = {N}_{ID}^{cell} mod 6 \qquad [ Equation 12 ]$$

In Equation 12, k represents a subcarrier index, 1 represents a symbol index, and p represents an antenna port index. N_{symb}^{DL} signifies a number of OFDM symbols within one downlink slot, N_{RB}^{DL} signifies a number of resource blocks being allocated (or assigned) to a downlink, nₛ signifies a slot index, and N_{ID}^{cell} signifies a cell ID. mod signifies modular calculation. And, the position of a reference signal in the frequency domain relies on a Vshift value. Since the Vshift value also relies on the cell ID, the position of the reference signal may have a different frequency shift value for each cell.

More specifically, in order to enhance channel estimation performance through the CRS, the position of the CRS within the frequency domain may be varied by being shifted for each cell. For example, in case reference signals are positioned at an interval of 3 subcarriers, one cell may be positioned on a subcarrier of 3k, and another cell may be positioned on a subcarrier of 3k+1. In the viewpoint of one antenna port, the reference signals are positioned at an interval of 6 REs (i.e., an interval of 6 subcarriers) within the frequency domain, and the reference signals maintain a distance (or interval) of 3 REs from a RE having a reference signal for another antenna port positioned therein within the frequency domain.

Additionally, power boosting may be applied with respect to the CRS. Herein, power boosting refers to bringing power from a RE other than the RE assigned (or allocated) for the reference signal, among resource elements (REs) of one OFDM symbol, and transmitting the reference signal at a higher power level.

The reference signal position in the time domain is positioned at constant intervals starting from symbol index (1) 0 of each slot as its starting point. The time interval is differently defined in accordance with the CP length. In case of a normal CP, it is positioned in symbol indexes 0 and 4 of the slot, and, in case of an extended CP, it is positioned in symbol indexes 0 and 4 of the slot. Only reference signals of a maximum of 2 antenna ports are defined in one OFDM symbol. Accordingly, when transmitting 4 transmission antennas, reference signals for Antenna Ports 0 and 1 are positioned in symbol indexes 0 and 4 of a slot (symbol indexes 0 and 3 in case of the extended CP), and reference signals for Antenna Ports 2 and 3 are positioned in symbol index 1 of the slot. However, the frequency position of the reference signals for Antenna Ports 2 and 3 are switched between one another in the 2^{nd} slot.

In order to support a Spectral Efficiency that is higher than that of the legacy (or conventional) 3GPP LTE (e.g., Release-8) system, a system having an extended antenna configuration (e.g., LTE-A system) may be designed. Herein, for example, the extended antenna configuration may correspond to a configuration of 8 transmission antennas. A system having such an extended antenna configuration is required to support user equipments that operate within the legacy antenna configuration, i.e., to support backward compatibility. Accordingly, a reference signal pattern according to the legacy antenna configuration is required to be supported, and a new reference signal pattern respective to an additional antenna configuration is required to be designed. Herein, if CRS for a new antenna port is added to a system having the conventional antenna configuration, it may be disadvantageous in that the data transmission rate may be decreased due to an abrupt increase in the reference signal overhead. Based upon the above-described details, a separate reference signal (CSI-RS) for performing channel status information (CSI) measurement for a new antenna port may be adopted in the LTE-A (Advanced) system, which corresponds to an evolved version 3GPP LTE.

Inter-Cell Interference Control Method

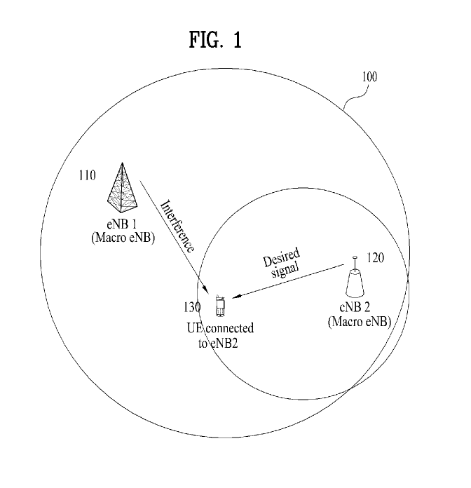

In case two base stations (eNB1 and eNB2) are adjacently positioned, and, in case the coverage of both base stations partially overlap one another, a strong downlink signal transmitted from one base station may cause interference on a user equipment being serviced by another base station. For example, in the example of FIG. 1, the user equipment (130), which is serviced by the micro base station (120), may be interfered by the signal transmitted from the macro base station (110). In case the inter-cell interference occurs as described above, two different methods of alleviating or removing (or eliminating) inter-cell interference between adjacent (or neighboring) cells may be broadly proposed. A first method corresponds to a method of alleviating interference by using a channel statistical characteristic of a signal, which is received from a neighboring (or adjacent) cell. For example, this may correspond to a method of removing an interference signal, by using a correlation between interference signals, which are received by multiple reception antennas, and combining the remaining signals. Additionally, a MMSE (Minimum Mean Square Error)-IRC (Interference Rejection combining) method also corresponds to such interference removing method. A second method corresponds to a method of detecting and removing a signal that is received from a neighboring cell. A PBCH (Physical Broadcast Channel) Cancellation method, a CRS (Common Reference Signal) removing method may correspond to this.

In case of applying the above-described interference alleviating removing methods, channel information corresponding to a statistical characteristic and an instantaneous characteristic respective to a channel of a neighboring cell is required. At this point, the channel information of a neighboring cell may be acquired by using CRS. The CRS is defined as parameters of a cell identifier (Cell Identification), a slot number, an OFDM (Orthogonal Frequency Division Multiple) symbol index (or number), a CP (Cyclic Prefix) length, a number of resource blocks (RBs), a number of transmission antennas. Generally, in a cellular system, for handover, and so on, the user equipment tracks and manages reception signal power or quality of a neighboring cell in addition to the serving cell. During this procedure, among the parameters for defining the CRS, the user equipment may acquire information excluding a number of downlink resource blocks and a number of transmission antennas.

The related art is disadvantageous in that, in order to determine (or know) the number of resource blocks and the number of transmission antennas of a neighboring cell, blind detection is required to be additionally performed on the PBCH of the neighboring cell. For example, this corresponds to a method, wherein detection of the PBCH is attempted after assuming that the number of antennas is equal to 1, and, then, when the detection is failed, detection of the PBCH is attempted once again after assuming that the number of antennas is equal to 2. Such detection procedure results in a waste of radio resource (or wireless resource).

According to the present invention, in order to remove or alleviate the interference between the cell, information on the number of downlink resource blocks and the number of transmission antennas of the neighboring cell may be effectively acquired.

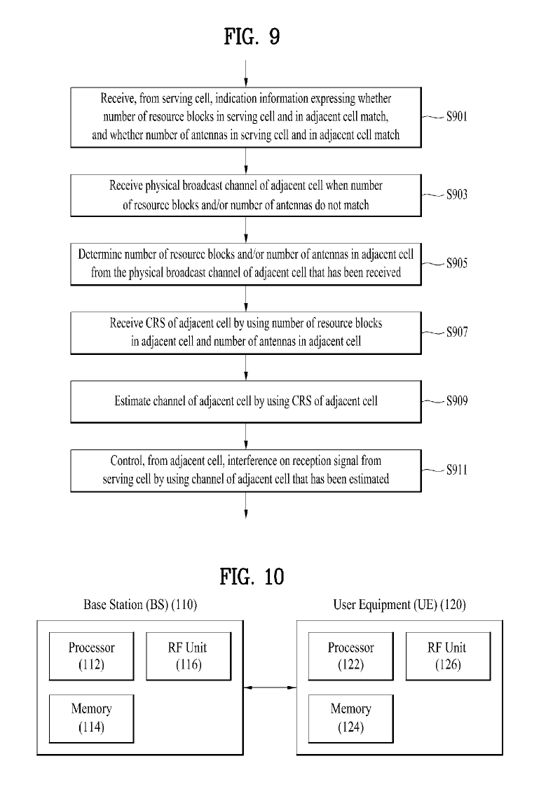

FIG. 9 illustrates a flow chart of a method for receiving control information for removing interference of a neighboring cell according to an exemplary embodiment of the present invention.

Hereinafter, a method that can allow the user equipment to efficiently receive control information without having to detect the PBCH of the neighboring cell each time will be described in detail with reference to FIG. 9.

First of all, the user equipment receives, from a serving cell, indication information expressing whether numbers of resource blocks in the serving cell and in an adjacent (or neighboring) cell match, and whether numbers of antennas in the serving cell and in the adjacent cell match (S901). More specifically, according to the present invention, instead of detecting the PBCH of a neighboring (or adjacent) cell each time, based upon the indication information, the PBCH of the neighboring cell may be detected only when required.

For example, in case both the numbers of resource blocks and the numbers of antennas in the serving cell and in the adjacent cell match, the indication information may correspond to 1-bit information that is assigned with “0”, and, in the remaining cases, the indication information may correspond to 1-bit information that is assigned with “1”. In case the indication information is equal to “0”, since the user equipment is capable of knowing the number of resource blocks and the number of antennas in the adjacent cell from the number of resource blocks and the number of antennas in the serving cell, the user equipment is not required to detect the PBCH of the adjacent cell. Conversely, in case the indication information is equal to “1”, since at least one of the numbers of resource blocks and the numbers of antennas in the adjacent cell does not match the corresponding information in the serving cell, the user equipment detect the PBCH of the adjacent cell (or neighboring cell).

Additionally, by assigning 1 bit to each of the numbers of resource blocks and the numbers of antennas, the indication information may correspond to 2-bit information indicating whether or not the numbers of resource blocks and the numbers of antennas match. For example, in case both the numbers of resource blocks and the numbers of antennas in the serving cell and in the adjacent cell match, the indication information may be assigned with “00”, and, in case the numbers of resource blocks are different and the numbers of antennas match, the indication information may be assigned with “01”, and, in case the numbers of resource blocks match and the numbers of antennas are different, the indication information may be assigned with “10”, and, in case both the numbers of resource blocks and the numbers of antennas are different, the indication information may be assigned with “11”. Although the numbers of resource blocks do not match, in case the numbers of antennas match, the blind detection process for determining the number of antennas may not be performed during the PBCH detection procedure.

Additionally, a message delivering the indication information may correspond to any one of multiple messages that will hereinafter be described in detail. However, the indication information may be included and transmitted not only in the messages described below but also in diverse types of messages that can deliver the indication information.

First of all, the indication information may be included and transmitted in a MIB (Master Information Block) message.

Table 2 shows an exemplary MIB message including the 1-bit indication information.

TABLE 2
--ASN1START

| MasterInformationBlock ::= | | SEQUENCE { |
|---|---|---|
| | dl-Bandwidth | ENUMERATED {n6, n15, n25, n50, n75, |
| | | n100}, |
| | phich-Config | PHICH-Config, |
| | systemFrameNumber | BIT STRING (SIZE (8)), |
| | BW_Ant | BIT STRING (SIZE (1)), |
| | spare | BIT STRING (SIZE (9)) |

}
--ASN1STOP

More specifically, the MIB message of Table 2 corresponds to a MIB message having “BW_Ant”, which corresponds to 1 bit in the MIB message of Table 1, added thereto as the indication information. The user equipment verifies the “BW_Ant” from the received MIB message of Table 2, thereby being capable of determining whether or not the PBCH of the adjacent cell is required to be detected. For example, in case the “BW_Ant” is equal to “0”, the user equipment may determine that both the numbers of resource blocks and both the number of antennas in the serving cell and the adjacent cell match, and, then, the user equipment may not detect the PBCH of the adjacent cell. Conversely, in case the “BW_Ant” is equal to “1”, the user equipment may determine that at least one of the numbers of resource blocks and the number of antennas of the serving cell and the adjacent cell are different, and, then, the user equipment may detect the PBCH of the adjacent cell.

Table 3 shows an exemplary MIB message including the 2-bit indication information.

TABLE 3
--ASN1START

| MasterInformationBlock ::= | | SEQUENCE { |
|---|---|---|
| | dl-Bandwidth | ENUMERATED {n6, n15, n25, n50, n75, |
| | | n100}, |
| | phich-Config | PHICH-Config, |
| | systemFrameNumber | BIT STRING (SIZE (8)), |
| | BW_Ant | BIT STRING (SIZE (2)), |
| | spare | BIT STRING (SIZE (8)) |

}
--ASN1STOP

More specifically, the MIB message of Table 3 corresponds to a MIB message having “BW_Ant”, which corresponds to 2 bits in the MIB message of Table 1, added thereto as the indication information. The user equipment verifies the “BW_Ant” from the received MIB message of Table 3, thereby being capable of determining whether or not the PBCH of the adjacent cell is required to be detected. For example, in case the “BW_Ant” is equal to “00”, the user equipment may determine that both the numbers of resource blocks and both the number of antennas in the serving cell and the adjacent cell match, and, then, the user equipment may not detect the PBCH of the adjacent cell. In case the “BW_Ant” is equal to “01”, the user equipment may determine that the numbers of resource blocks of the serving cell and the adjacent cell are different and that the number of antennas of the serving cell and the adjacent cell match, and, then, the user equipment may receive the PBCH without performing any blind detecting procedure in order to know the number of antennas, thereby being capable of knowing the number of resource blocks. In case the “BW_Ant” is equal to “11”, the user equipment determines that both the numbers of resource blocks and both the numbers of antennas of the serving cell and the adjacent cell are different, and, then, the user equipment receives the PBCH of the adjacent cell by performing a blind detecting procedure, thereby being capable of knowing the number of antennas and the number of resource blocks.

Additionally, the indication information may be included and transmitted in a SIB (System Information Block) message. For example, the SIB message may be used by using a method of allocating indication information to reserved bits among SIB Type1 to SIB Type13. At this point, the indication information may be assigned (or allocated) to 1 bit or 2 bits, and the indication information may be allocated to 1 bit or 2 bits by using the same method that is described above in the MIB message.

Additionally, the indication information may be included and transmitted in a RA-RNTI (Random Access-Radio Network Temporary Identifier). This method corresponds to a method of having the serving cell notify user equipments receiving the PDCCH of information on the number of resource blocks and the number of antennas of an adjacent cell within an adjacent cell list or a tracking area by using the RA-RNTI. At this point, the indication information may be assigned (or allocated) to 1 bit or 2 bits, and the indication information may be allocated to 1 bit or 2 bits by using the same method that is described above in the MIB message.

Additionally, the indication information may be allocated and transmitted in a UE-specific channel (e.g., PDSCH), a reserved area (or region) within a RRC signaling message, or a reserved area (or region) within a MAC (Medium Access Control) element message. At this point, the indication information may be assigned (or allocated) to 1 bit or 2 bits, and the indication information may be allocated to 1 bit or 2 bits by using the same method that is described above in the MIB message.

Additionally, the user equipment may periodically receive the indication information from the serving cell. In this case, by periodically transmitting the indication information regardless of the presence or absence of a request made by the user equipment, the user equipment may omit the process of requesting the indication information. Conversely, in case the indication information is aperiodically required, the user equipment may receive the indication information by making a request to the serving cell. In this case, the waste of wireless resources (or radio resources) by having the indication information be frequently transmitted, even when the indication information is not used frequently, may be prevented.

Furthermore, in case multiple adjacent cells exist, the user equipment may receive indication information respective to each of the adjacent cells and may also receive an identifier that can identify each of the adjacent cells along with the respective indication information. For example, in case there are 2 adjacent cells, in a bit region that is allocated for the indication information, allocation may be performed in an order of indication information respective to a first adjacent cell in a first bit region, a cell identifier of the first adjacent cell in a second bit region, indication information respective to a second adjacent cell in a third bit region, and a cell identifier of the second adjacent cell in a fourth bit region.

Subsequently, in accordance with the received indication information, the user equipment receives a physical broadcast channel of the adjacent cell when the numbers of resource blocks and/or the numbers of antennas do not match (S903) and, then, determines the number of resource blocks and/or the number of antennas (S905). For example, as a 1-bit indication information, in case the indication information indicates a full match or at least one non-match, when the received indication information has a value indicating at least one non-match, the user equipment detects the PBCH by performing blind detecting, thereby detecting the number of antennas and the number of resource blocks. Moreover, as a 2-bit indication information, when the indication information is capable of indicating whether or not each of the numbers of resource blocks and each of the numbers of antennas match, the user equipment may receive only the information that does not match. For example, when the numbers of antennas match, and when the numbers of resource blocks do not match, the user equipment may determine the number of resource blocks by receiving the PBCH of the adjacent cell without performing a blind detecting procedure for detecting the number of antennas.

Thereafter, the user equipment may receive CRS of the adjacent cell by using the number of resource blocks in the adjacent cell and the number of antennas in the adjacent cell (S907). As described above, among the information defining the CRS, with the exception for the number of resource blocks and the number of antennas, since the cell identifier, the slot number, the OFDM symbol number, the CP length are known, the CRS of the adjacent cell may be received once the number of resource blocks and the number of antennas are known.

Finally, the user equipment may estimate a channel of the adjacent cell by using CRS of the adjacent cell (S909). When the user equipment estimates the channel of the adjacent cell by using the CRS of the adjacent cell, by applying one of the above-described interference control methods, the user equipment may control the interference caused by the adjacent cell on the reception signal, which is received from the serving cell (S911).

FIG. 10 illustrates a base station and a user equipment that can be applied to an exemplary embodiment of the present invention.

Referring to FIG. 10, a wireless communication device includes a base station (BS) (110) and a user equipment (UE) (120). In a downlink, a transmitter is part of the base station (110), and a receiver is part of the user equipment (120). In an uplink, the transmitter is part of the user equipment (120), and the receiver is part of the base station (110). The base station (110) includes a processor (112), a memory (114), and a Radio Frequency (RF) unit (116). The processor (112) may be configured to realize the procedures and/or methods, which are proposed in the present invention. The memory (114) is connected to the processor (112) and stores diverse information related to the operations of the processor (112). The RF unit (116) is connected to the processor (112) and transmits and/or receives radio signals. The user equipment (120) includes a processor (122), a memory (124), and a RF unit (126). The processor (122) may be configured to realize the procedures and/or methods, which are proposed in the present invention. The memory (124) is connected to the processor (122) and stores diverse information related to the operations of the processor (122). The RF unit (126) is connected to the processor (122) and transmits and/or receives radio signals. The base station (110) and/or the user equipment (120) may have a single antenna or multiple antennas.

The above-described embodiments of the present invention correspond to predetermined combinations of elements and features and characteristics of the present invention. Moreover, unless mentioned otherwise, the characteristics of the present invention may be considered as optional features of the present invention. Herein, each element or characteristic of the present invention may also be operated or performed without being combined with other elements or characteristics of the present invention. Alternatively, the embodiment of the present invention may be realized by combining some of the elements and/or characteristics of the present invention. Additionally, the order of operations described according to the embodiment of the present invention may be varied. Furthermore, part of the configuration or characteristics of any one specific embodiment of the present invention may also be included in (or shared by) another embodiment of the present invention, or part of the configuration or characteristics of any one embodiment of the present invention may replace the respective configuration or characteristics of another embodiment of the present invention. Furthermore, it is apparent that claims that do not have any explicit citations within the scope of the claims of the present invention may either be combined to configure another embodiment of the present invention, or new claims may be added during the amendment of the present invention after the filing for the patent application of the present invention.

In this document, the exemplary embodiments of the present invention are described mainly based upon a transmitting and receiving relation between the user equipment and the base station. In this document, particular operations of the present invention that are described as being performed by the base station may also be performed by an upper node of the base station. More specifically, in a network consisting of multiple network nodes including the base station, it is apparent that diverse operations that are performed in order to communicate with the terminal may be performed by the base station or b network nodes other than the base station. The term base station may be replaced by other terms, such as fixed station, Node B, eNode B (eNB), Access Point (AP), and so on. Furthermore, the term terminal (or user terminal) may be replaced by other terms, such as UE (User Equipment), MS (Mobile Station), MSS (Mobile Subscriber Station), and so on.

The above-described embodiments of the present invention may be implemented by using a variety of methods. For example, the embodiments of the present invention may be implemented in the form of hardware, firmware, or software, or in a combination of hardware, firmware, and/or software. In case of implementing the embodiments of the present invention in the form of hardware, the method according to the embodiments of the present invention may be implemented by using at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, micro controllers, micro processors, and so on.

In case of implementing the embodiments of the present invention in the form of firmware or software, the method according to the embodiments of the present invention may be implemented in the form of a module, procedure, or function performing the above-described functions or operations. A software code may be stored in a memory unit and driven by a processor. The memory may be located inside or outside of the processor, and the memory unit may transmit and receive data to and from the processor by using a wide range of methods that have already been disclosed.

The present invention may be realized in another concrete configuration (or formation) without deviating from the scope and spirit of the essential characteristics of the present invention. Therefore, in all aspect, the detailed description of present invention is intended to be understood and interpreted as an exemplary embodiment of the present invention without limitation. The scope of the present invention shall be decided based upon a reasonable interpretation of the appended claims of the present invention and shall come within the scope of the appended claims and their equivalents.

### INDUSTRIAL APPLICABILITY

Although a method for transmitting data in a wireless communication system of the present invention is described based upon an example that can be applied to a 3GPP LTE system, the method of the present invention may also be applied to a variety of other wireless access systems in addition to the 3GPP LTE system.

What is claimed is:

1. A method for receiving control information for removing interference of an adjacent cell in a wireless access system, the method for receiving control information comprising:
receiving, from a serving cell, indication information expressing whether numbers of resource blocks in a serving cell and in an adjacent cell match, and whether numbers of antennas in the serving cell and in the adjacent cell match;
receiving a physical broadcast channel (PBCH) of the adjacent cell when the numbers of resource blocks and/or the numbers of antennas do not match; and
determining the number of resource blocks and/or the number of antennas of the adjacent cell from the physical broadcast channel in the adjacent cell that has been received.

2. The method of claim 1, wherein the indication information is given a matching value when both the numbers of resource blocks and the numbers of antennas match, and
wherein the indication information is given a non-matching value when at least one of the numbers does not match.

3. The method of claim 2, wherein, if the indication information is given a matching value, the number of resource blocks and the number of antennas of the adjacent cell are determined from the received physical broadcast channel of the adjacent cell.

4. The method of claim 1, wherein the indication information comprises first information indicating whether or not the numbers of resource blocks match, and second information indicating whether or not the numbers of antennas match.

5. The method of claim 4, wherein information corresponding to the non-match is determined from the received physical broadcast channel of the adjacent cell when at least one of the first information and the second information indicates a non-match.

6. The method of claim 1, wherein the indication information is received through a MIB (Master Information Block) message.

7. The method of claim 1, wherein the indication information is received through a RA-RNTI (Random Access-Radio Network Temporary Identifier) message.

8. The method of claim 1, wherein the indication information is received through a PDSCH (Physical Downlink Control Channel).

9. The method of claim 1, wherein the indication information is received through a MAC (Medium Access Control) control element.

10. The method of claim 1, wherein the indication information is received through a RRC (Radio Resource Control) message.

11. The method of claim 1, wherein the indication information is received through a SIB (System Information Block) message.

12. The method of claim 1, further comprising:
receiving CRS of the adjacent cell by using the number of resource blocks of the adjacent cell and the number of antennas of the adjacent cell.

13. The method of claim 12, further comprising:
estimating a channel of the adjacent cell by using the CRS of the adjacent cell.

14. The method of claim 13, further comprising:
controlling interference caused by the adjacent cell in a receiving signal transmitted from the serving cell by using the estimated channel of the adjacent cell.

15. A user equipment receiving control information for removing interference of an adjacent cell in a wireless access system, the user equipment comprising:
a RF (Radio Frequency) unit; and
a processor,
wherein the processor is configured to:
receive, from a serving cell, indication information expressing whether numbers of resource blocks in a serving cell and in an adjacent cell match, and whether numbers of antennas in the serving cell and in the adjacent cell match,
receive a physical broadcast channel (PBCH) of the adjacent cell when the numbers of resource blocks and/or the numbers of antennas do not match, and
determine the number of resource blocks and/or the number of antennas of the adjacent cell from the physical broadcast channel in the adjacent cell that has been received.
